(19) United States
(12) Patent Application Publication
(10) Pub. No.: US 2014/0318479 A1
(43) Pub. Date: Oct. 30, 2014

(54) Protective Poultry Saddle

(71) Applicants: David Michael Marszalec, Morrison, CO (US); Jill Yuen Chin Bong, Morrison, CO (US)

(72) Inventors: David Michael Marszalec, Morrison, CO (US); Jill Yuen Chin Bong, Morrison, CO (US)

(21) Appl. No.: 14/326,279

(22) Filed: Jul. 8, 2014

Related U.S. Application Data
(63) Continuation-in-part of application No. 13/757,953, filed on Feb. 4, 2013.

(51) Int. Cl. A01K 13/00; A01K 45/00

(52) U.S. Cl. CPC A01K 13/006; A01K 45/00
USPC 119/853

(57) ABSTRACT

A one-piece rectangular protective cape-like device worn by poultry that covers the main back of the poultry. Two opposing lateral slits are cut into the main saddle piece to form straps. The saddle holds on to the bird by pulling each wing through the respective slit. Weather-resistant material such as reinforced scrim vinyl, Tyvek or other similar material is used. Additional text, color or designs may be printed directly onto the saddle material. Close-set ocelli may be added to depict the presence of predator eyes.

### FIELD OF THE INVENTION

The present invention relates to a protective poultry saddle apparatus which protects the backs of poultry during mating and/or during molting. It may also be used to prevent predator attacks, and to deter scavenger birds from co-mingling with the poultry flock.

### BACKGROUND OF THE INVENTION

Hens can sustain feather loss and injury on their backs during mating, molting or from feather-picking. Such injuries can cause picking or infection which can lead to cannibalism and death. This behaviour can be seen in both domestic and commercial flocks. A poultry bird who has sustained feather loss or injury must either be separated from the flock, or have its back covered to prevent further damage.

Some protective saddles have been developed to protect poultry. However, to date, existing poultry saddles are made with too many components and have complicated designs. Material choices such as canvas, denim or cloth make existing saddle designs difficult to clean. These problems increase the cost and price of the final product, making it unaffordable and/or difficult to maintain, especially when worn by larger flocks.

The main predator of pastured or free-ranging poultry are hawks, while birds that scavenge on poultry food include blackbirds and English sparrows.

Prior art claims the use of visible warning indicia shaped to resemble a pair of eyes as a predator deterrent. However, eyes set wide-apart indicate eyes of prey, thereby potentially increasing the risk to the poultry they are meant to protect.

Therefore, a need exists to overcome problems that exist with prior art as discussed above,

### SUMMARY OF THE INVENTION

Briefly, in accordance with the present invention, disclosed is a protective poultry saddle generally made from a single piece of material including but not limited to, scrim vinyl or Tvyek® material. Typically, the poultry saddle can be cut into a rectangular or rectangle-like shape. The poultry saddle requires no sewing to manufacture, and requires no additional fastening fixtures such as buttons, Velcro®, fasteners or elastic straps to keep the apparatus on the back of the poultry. More specifically, the poultry saddle pertains to a single-piece poultry saddle.

In one embodiment, a pair of slits can be cut into the piece of material.

The slits can be implemented as two lateral “straps” , through which each wing of a bird can be pulled through.

The result is the rectangular apparatus which covers the length of the back of the poultry bird,

In one embodiment, the poultry saddle can include slits having a rectangular shape.

In another embodiment, the poultry saddle can include slits having a parabolic shape.

In yet another embodiment, the poultry saddle can include slits having a rectangular shape that have a circle cut out at a top and/or bottom of the slits.

In one embodiment, the poultry saddle can include an eye design. For instance, the eye design can include one outer red and one inner yellow concentric circle overlaid on a black background having a figure eight shape. Alternatively, the circles can be reversed including one inner red and one outer yellow concentric circle, overlaid on a black background having a figure eight shape. Generally, the eye design can be centered slightly above the bottom portion of the poultry saddle.

The eye design can be implemented to make the final art appear to look like ocelli or “eyes”. The ocelli are typically made from decals, which can be applied to the poultry saddle or printed directly onto the poultry saddle.

Generally, the pair of eyes can be set very close together, or are attached to each other, to represent the forward-facing binocular vision of most predators.

In one embodiment, the poultry saddle can include the addition of color, text, patterns and/or other designs. For instance, the poultry saddle can have advertisements printed directly onto the poultry saddle.

Although the invention is illustrated and described herein as embodied in a protective poultry saddle, it is, nevertheless, not intended to be limited to the details shown because various modifications and structural changes may be made therein without departing from the spirit of the invention and within the scope and range of equivalents of the claims.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

### BRIEF DESCRIPTION OF DRAWINGS

FIG. 1A is a top view of a poultry saddle according to one embodiment of the present invention.

FIG. 1B a top view of a poultry saddle including predator eye decals according to one embodiment of the present invention.

FIG. 1C includes a color variation to the design shown in FIG. 1B

FIG. 1D is a top view of a poultry saddle according to one embodiment of the present invention.

FIG. 1E is a top view of a poultry saddle according to one embodiment of the present invention.

FIG. 1F is a top view of a poultry saddle according to one embodiment of the present invention.

### DETAILED DESCRIPTION OF THE INVENTION

The present invention provides a poultry saddle, made from one-piece of weather and/or puncture-resistant material, which can be worn by chickens, turkeys and other poultry, to protect their backs from other birds, or further injury, allowing for feather growth.

The addition of close-set ocelli to the tail-end of the saddle represents the presence of predator eyes.

The present invention overcomes the disadvantages and limitations of the prior art by providing an apparatus to protect the backs of poultry during mating which is weather-resistant. The use of slits to make effective straps is simpler in design and therefore more cost-effective to produce.

The saddles can be made from various weather and puncture-resistant materials, such as, but not limited to, reinforced scrim vinyl material or Tvyek® instead of the traditional use of canvas, denim or cloth.

Use of weather-resistant materials allows the saddles to be hosed clean, instead of needing to be laundry washed.

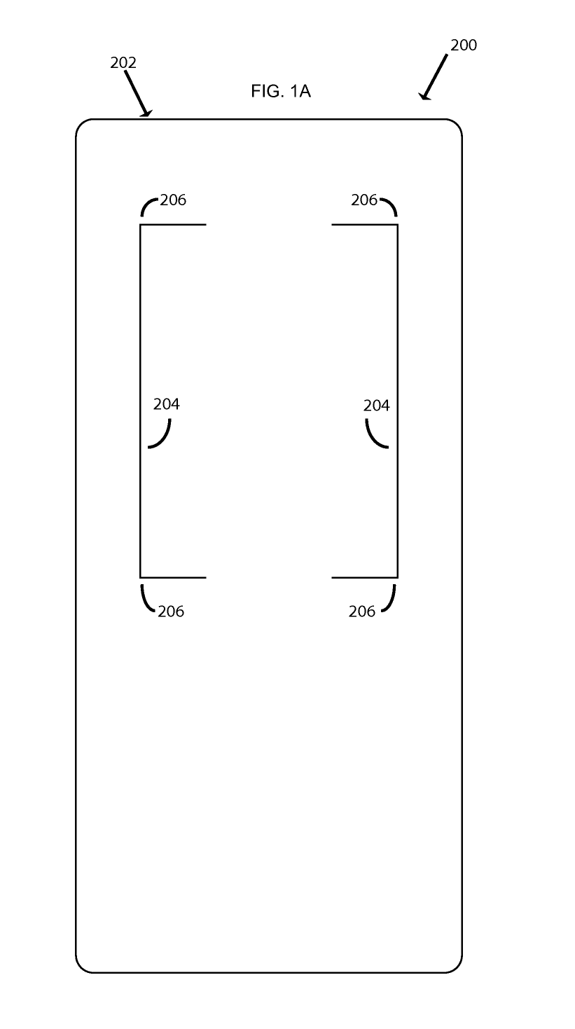

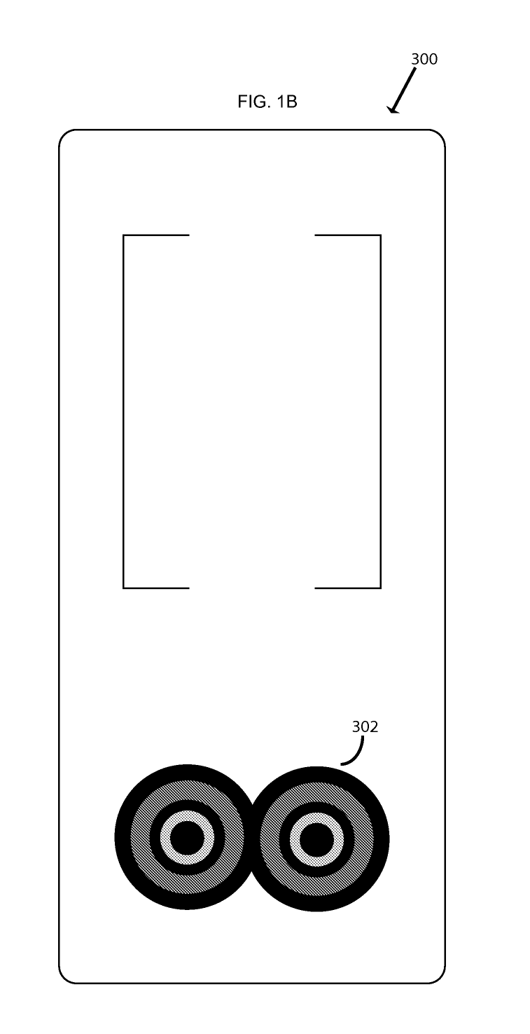

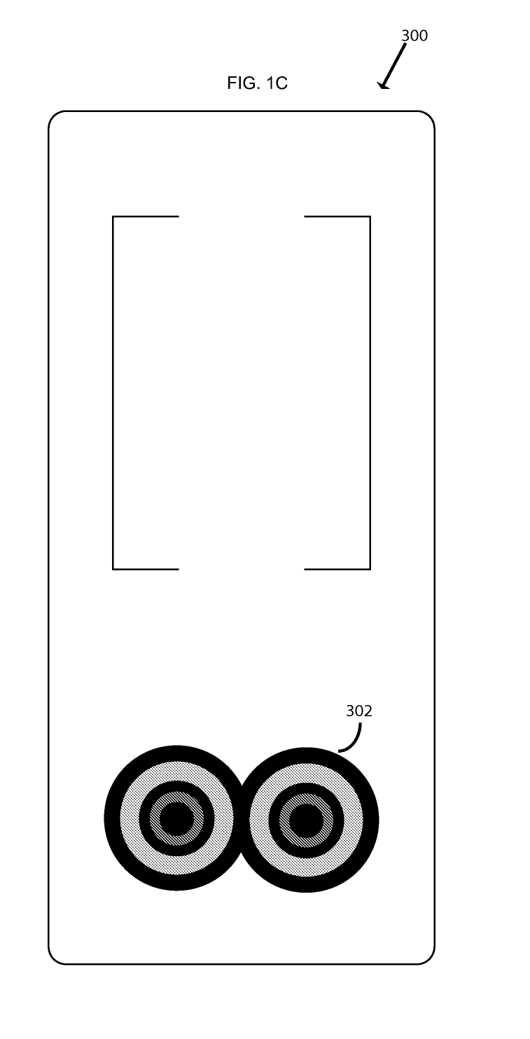

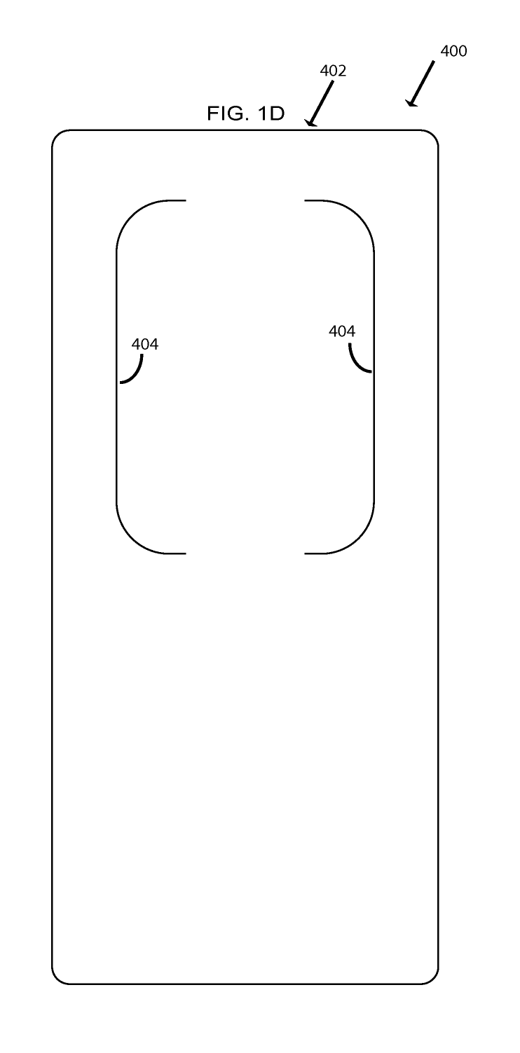

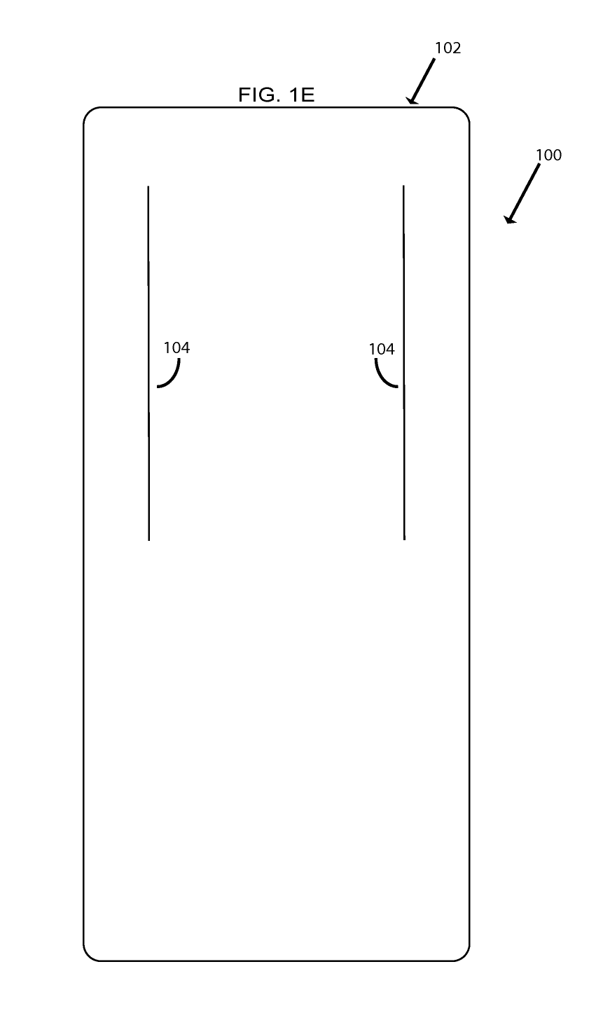

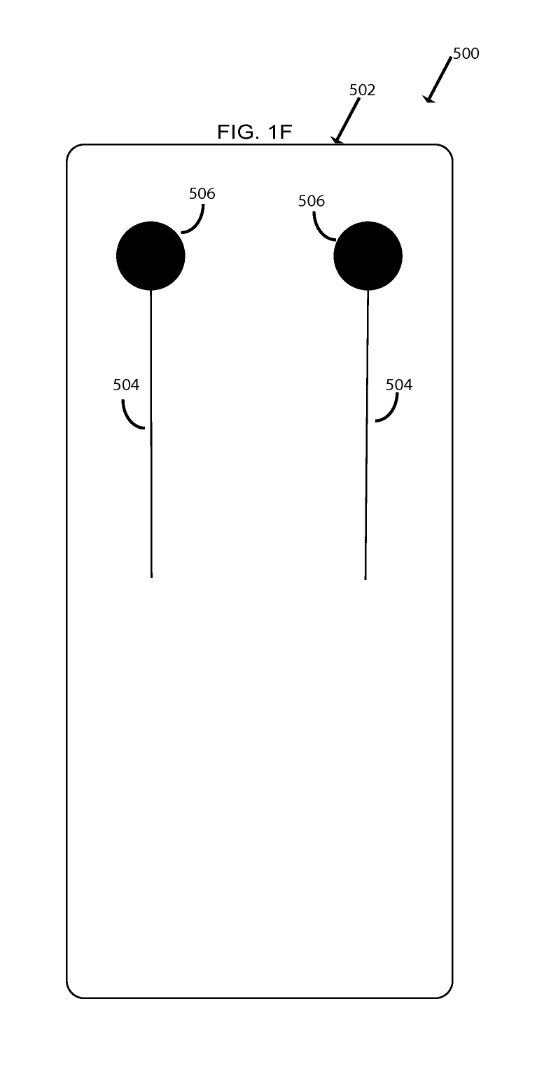

As shown in FIG. 1E, the poultry saddle 100 can generally include a panel of fabric 102 and a pair of slits 104.

Generally, the poultry saddle can be cut to size using a mat-cutter. In one embodiment, the poultry saddles can be cut into rectangular panels having a rectangular dimension of approximately 9.5″×4.25″ for a standard chicken size. In another embodiment, the poultry saddles can be cut into rectangular panels having dimensions of approximately 6.5″×3″ for a bantam-sized chicken. It is to be appreciated that the dimensions may be modified to fit the poultry in question accordingly.

As shown in FIG. 1E, the pair of elongated slits 104 can be cut into the saddles. For standard sized saddles, the slits 104 can be made at approximately 1″ from a shorter end of the rectangular panel and approximately 0.75″ from a longer side of the rectangular panel 102. Generally, the longest part of the slits 104 can lie parallel to the longer side of the rectangular panel 102. In one embodiment, the longest part of the slit 104 can be approximately 4″ long and a pair of shorter slits 106 that are perpendicular to the slits 104 can be approximately 0.6″ long. Generally, the distance between the two longer sides of the slits 104 can be approximately 2.5″.

For bantam sized saddles, the slits 104 can be made at approximately 0.75″ from a shorter end of the rectangle and approximately 0.75″ from a longer side of the rectangle. Generally, the longest part of the slits 104 can lie parallel to the longer side of the rectangle. In one embodiment, the longest part of the slit 104 can be approximately 2.1″ long and the pair of shorter slits 106 that are perpendicular to the slits 104 can be approximately 0.375″ long. Typically, the distance between the two longest sides of the slits 104 can be approximately 1.5″.

It is to be appreciated that additional variations in sizes may be customized to fit a specific poultry size.

In one embodiment, as shown in FIG. 1E, the outer corners of the saddle can be cut away. For instance, the corners can be cut by using a pair of scissors such that the cut-off portion is an isosceles triangle.

In one embodiment, the internal slits 104 can be made using a template and an exacto knife. In another embodiment, the poultry saddle 102 may be die-cut with a custom-made die.

As shown in FIG. 1A, a poultry saddle 200 can generally include a panel of fabric 202, pair of slits 204, and a plurality of slits 206. The panel of fabric 202 can typically have a rectangular shape. Generally, the pair of elongated slits 204 and the plurality of slits 206 can be cut into the saddle 200. As shown, the plurality of slits 206 can be cut perpendicular to the pair of slits 204.

In one embodiment, the pair of slits 204 can be made at about 1″ from a shorter end of the panel and approximately 0.75″ from longer sides of panel 202. The pair of slits 204 can generally lie parallel to the longer sides of the panel 202. In one embodiment, the pair of slits 204 can be about 4″ long and the plurality of slits 206 can be about 0.6″ long. Generally, the pair of slits 204 can be spaced approximately 2.5″ apart.

In another embodiment, the pair of slits 204 can be made at about 0.75″ from the shorter end of panel 202 and approximately 0.75″ from the longer sides of panel 202. Typically, the pair of slits 204 can be parallel to the longer sides of panel 202. The pair of slits can be about 2.1″ long and the plurality of slits 206, that are perpendicular to the pair of slits 204, can be about 0.375″ long. The distance between the pair of the slits 204 can be approximately 1.5″.

It is appreciated that additional. variations in sizes may be customized to fit a specific poultry size.

In one embodiment, the outer corners of the saddle can be cut away using a pair of scissors such that the cut-off portion is an isosceles triangle.

The application of the slits produces two straps on each of the lateral sides of the apparatus.

Referring to FIG. 1D, a poultry saddle 400 is illustrated. Generally, the poultry saddle 400 can be implemented similar to the poultry saddle 100. The poultry saddle 400 can include a panel 402 and a pair of slits 404. As shown, the pair of slits 404 can have a parabolic shape.

Referring to FIG. 1F, a poultry saddle 500 is illustrated. Generally, the poultry saddle 500 can be implemented similar to the poultry saddle 100. The poultry saddle 500 can include a panel 502, a pair of slits 504, and a pair of holes 506. As shown, the pair of slits 504 can be similar to the pair of slits 104. The poultry saddle 500 can include the holes 506 proximate ends of the pairs of slits 504 to allow a wing of a poultry to fit into the pair of slits 502.

In a typical implementation, the poultry saddle can be secured to the poultry by pulling the bird's wings through each of the respective straps, one on each side of the saddle. The straps lie under over the humerus and around the shoulder of each of the respective poultry's wing.

Referring to FIGS. 1B and 1C, an embodiment 300 of the apparatus can include the addition of a pair of close-set ocelli 302, or eyes, designed to resemble those of forward-facing predator eyes may be printed on, or applied to the saddles as decals.

In all embodiments, additional colors or patterns may be drawn or printed onto the material, or decals may be applied onto the material.

In accordance with another feature, the embodiment 300 of the present invention can include the addition of one outer red and one inner yellow concentric circle, as shown in FIG. 1B, or one inner red and one outer yellow concentric circle, as shown in FIG. 1C, overlaid on a black “figure-8” background, which is centered slightly above the bottom base of the poultry saddle.

The embodiment 300 can generally be designed to make the final art appear to look like “eyes”. In one embodiment, the “eyes” are made from decals that can be are applied to the poultry saddle, In another embodiment, the “eyes” can be printed directly onto the poultry saddle.

We claim:

1. A protective poultry saddle comprising:
a panel having a substantially rectangular shape, the panel adapted to cover a back of a bird, the panel being defined by a main body area having a length and a width; and
a pair of slits cut laterally on each lateral side of the panel forming straps that lie under over a humerus and around a shoulder of a wing of a poultry.

2. The poultry saddle of claim 1, wherein the panel is cut out of one piece of weather and puncture-resistant material.

3. The poultry saddle of claim 2, wherein the material is selected from a group consisting of Tyvek and scrim vinyl.

4. The poultry saddle of claim 1, wherein the poultry saddle includes at least one decal.

5. The poultry saddle of claim 4, wherein the decal is of a pair of close-set ocelli.

6. The poultry saddle of claim 5, wherein the ocelli resemble forward-facing of a predator.

7. The poultry saddle of claim 1, wherein one or more designs are printed onto the poultry saddle.

8. The poultry saddle of claim 7, wherein the one or more designs include a pair of close-set ocelli.

9. The poultry saddle of claim 8, wherein the ocelli resemble forward-facing eyes of a predator.

10. The poultry saddle of claim 1, wherein the pair of slits each have a parabolic shape.

11. A protective poultry saddle comprising:
a panel having a substantially rectangular shape, the panel adapted to cover a back of a bird, the panel being defined by a main body area having a length and a width;
a first pair of slits cut laterally on each lateral side of the panel forming straps that lie under over a humerus and around a shoulder of a wing of a poultry; and
a plurality of slits cut perpendicular to the first pair of slits, the plurality of slits located proximate ends of the first pair of slits.

12. The poultry saddle of claim 11, wherein the panel is cut out of one piece of weather and puncture-resistant material.

13. The poultry saddle of claim 12, wherein the material is selected from a group consisting of Tyvek and scrim vinyl.

14. The poultry saddle of claim 11, wherein the poultry saddle includes at least one decal.

15. The poultry saddle of claim 14, wherein the decal is a pair of close-set ocelli.

16. The poultry saddle of claim 15, wherein the ocelli resemble forward-facing eyes predator.

17. The poultry saddle of claim 11, wherein one or more designs are printed onto the poultry saddle.

18. The poultry saddle of claim 17, wherein the one or more designs include a pair of close-set ocelli.

19. The poultry saddle of claim 18, wherein the ocelli resemble forward-facing eyes of a predator.

20. The poultry saddle of claim 11, Wherein the pair of slits each have a parabolic shape.
